(19) United States
(12) Patent Application Publication
(10) Pub. No.: US 2004/0131309 A1
(43) Pub. Date: Jul. 8, 2004

(54) Tunable optical filter, optical switch, and optical add/drop multiplexer employing linearly variable thin film optical filters

(76) Inventors: Xinxiong Zhang, Arcadia, CA (US); Vincent E. Stenger, West Covina, CA (US)

Correspondence Address: CHRISTIE, PARKER & HALE, LLP, P.O. BOX 7068, PASADENA, CA, 91109-7068, US

(21) Appl. No.: 10/654,695

(22) Filed: Sep. 3, 2003

Related U.S. Application Data
(60) Provisional application No. 60/407,280, filed on Sep. 3, 2002.
(60) Provisional application No. 60/407,281, filed on Sep. 3, 2002.
(60) Provisional application No. 60/407,282, filed on Sep. 3, 2002.
(60) Provisional application No. 60/407,283, filed on Sep. 3, 2002.

(51) Int. Cl. G02B 6/28

(52) U.S. Cl. 385/24; 385/18

(57) ABSTRACT

A reconfigurable non-blocking Optical Add/Drop Module (OADM) using linearly variable thin film optical filters. The OADM is tunable to drop one or more target channels from an optical signal without interfering with any channels between a starting channel and the dropped channels. During tuning, all of the channels in the optical signal are expressed. In one embodiment of the OADM, two linearly variable thin film optical filters are optically coupled in a cascade series such that one or more channels may be dropped by tuning both to the dropped channels. The optical filters are electronically coupled to a common controller that controls the operation of each of the linearly variable thin film optical filters. The filters are tuned separately to reach the target dropped channels without interfering with any intermediate channels.

### CROSS-REFERENCE TO RELATED APPLICATIONS

This application claims the benefit of U.S. Provisional Patent Application No. 60/407,281, filed Sep. 3, 2002, U.S. Provisional Patent Application No. 60/407,280, filed Sep. 3, 2002, and U.S. Provisional Patent Application No. 60/407,283, filed Sep. 3, 2002, and U.S. Provisional Patent Application No. 60/407,282, filed Sep. 3, 2002, the contents of which are hereby incorporated by reference as if fully stated herein.

### BACKGROUND OF THE INVENTION

As the number of nodes in a Wavelength Division Multiplexing (WDM) optical network increase, channel routing via conventional optical to electrical, and electrical to optical conversions degrade signal quality and speed. It is therefore desirable to implement all-optical, reconfigurable channel (wavelength) routing and bandwidth allocation at the optical filter level. A core component used to achieve optical channel routing is a reconfigurable, non-blocking, Optical Add/Drop Module (OADM). A reconfigurable non-blocking OADM permits dynamic selection and rerouting of optical channels in a WDM optical signal without interfering with other optical channels in the WDM optical signal. The rerouted channels are called “dropped” channels and the other channels are termed “expressed” channels.

Many prior reconfigurable non-blocking OADMs fail to achieve true non-blocking operation during a transition time when the OADM is being reconfigured to drop a new set of channels. As the OADM is reconfigured, each intermediate channel between a starting channel and a target channel are dropped and then expressed as the OADM scans through the channels to the target channel. As a channel is dropped and then expressed, any signals carried by the channel may be lost, thus introducing unwanted noise in the channel.

An improved OADM should feature adjustable optical channel selection. In addition, such a device should not interfere with intermediate channels as the device is tuned from one channel to another, thus achieving true non-blocking operation at all times. In addition, it would be advantageous to have an OADM that included an adjustable optical bandwidth so that one or more optical channels may be dropped and rerouted within a single device. Such an adjustable or “flexible” bandwidth device enables dynamic scalability of the network. As bandwidth needs at a node change, the device can upgrade or downgrade accordingly for more efficient use of network resources.

### SUMMARY OF THE INVENTION

A reconfigurable non-blocking Optical Add/Drop Module (OADM) using linearly variable thin film optical filters is provided. The OADM is tunable to drop one or more target channels from an optical signal without interfering with any channels between a starting channel and the dropped channels. During tuning, all of the channels in the optical signal are expressed. In one embodiment of the OADM, two linearly variable thin film optical filters are optically coupled in a cascade series such that one or more channels may be dropped by tuning both to the dropped channels. The optical filters are electronically coupled to a common controller that controls the operation of each of the linearly variable thin film optical filters. The filters are tuned separately to reach the target dropped channels without interfering with any intermediate channels.

In one aspect of the invention, a tunable wavelength filter includes an optical path having an input port and a drop port. A linearly variable filter is included within the optical path with an actuator mechanically coupled to the linearly variable filter. The actuator is operable to position a portion of the linearly variable filter corresponding to an optical channel in the optical path.

In another aspect of the invention, a second linearly variable filter is positioned within the optical path such that the second linearly variable filter is optically coupled to the first linearly variable filter. A second actuator is mechanically coupled to the second linearly variable filter. The second actuator is operable to position a portion of the second linearly variable filter corresponding to an optical channel in the optical path.

In another aspect of the invention, the portion of the first linearly variable filter positioned in the optical path corresponds to a plurality of optical channels and the portion of the second linearly variable filter positioned in the optical path corresponds to a plurality of optical channels.

In another aspect of the invention, the tunable wavelength filter further includes a first collimator receiving a reflected optical signal generated by the linearly variable filter in response to an input optical signal and a second collimator optically coupled to the first collimator receiving the reflected optical signal from the first collimator and transmitting the reflected optical back to the linearly variable filter.

In another aspect of the invention, the tunable wavelength filter includes a linearly variable filter and a plurality of movable mirrors defining an optical path through a portion of the linearly variable filter corresponding to an optical channel.

In another aspect of the invention, the tunable wavelength filter further includes a first plurality of collimators corresponding to a first set of ports and a second plurality of collimators corresponding to a second set of ports. The movable mirrors are operable to define a path through the linearly variable filter and between a first collimator selected from the first plurality of collimators and a second collimator selected from the second plurality of collimators.

### BRIEF DESCRIPTION OF THE DRAWINGS

These and other features, aspects, and advantages of the present invention will become better understood with regard to the following description, appended claims, and accompanying drawings where:

FIG. 1a to FIG. 1c are graphical representations of the operation of a non-blocking tunable filter in accordance with an exemplary embodiment of the present invention;

FIG. 2a is a diagram of a linearly variable filter in accordance with an exemplary embodiment of the present invention;

FIG. 2b is a graphical representation of the transmission characteristics as a function of distance along an X axis of the linearly variable filter of FIG. 2a in accordance with an exemplary embodiment of the present invention;

FIG. 2c is a graphical representation of the center wavelength and spectrum of a transmitted optical signal as a function of the X axis of the linearly variable filter of FIG. 2a in accordance with an exemplary embodiment of the present invention;

FIG. 2d is a block diagram of the operation of a wavelength tunable filter in accordance with an exemplary embodiment of the present invention;

FIG. 3 is a block diagram of a non-blocking tunable filter employing two linearly variable filters in accordance with an exemplary embodiment of the present invention;

FIG. 4a to FIG. 4b are a sequence of graphs illustrating the operation of a non-blocking tunable filter in accordance with an exemplary embodiment of the present invention;

FIG. 5 is a sequence diagram of the operations of a non-blocking tunable filter in accordance with an exemplary embodiment of the present invention; and

FIG. 6a to FIG. 6c are graphical representations of the operation of a flexible bandwidth non-blocking tunable filter in accordance with an exemplary embodiment of the present invention.

FIG. 7 is a block diagram of a cascaded non-blocking tunable filter of FIG. 3 in accordance with an exemplary embodiment of the present invention;

FIG. 8 is a block diagram of a wavelength selective optical switch employing a linear optical filter and mirrors in accordance with an exemplary embodiment of the present invention; and

FIG. 9 is a block diagram of a multiport, wavelength selective optical switch employing a linear optical filter and mirrors in accordance with an exemplary embodiment of the present invention.

### DETAILED DESCRIPTION

To achieve non-blocking or “hitless” operation in a tunable WDM filter module, reflection band (express) channels should be unaffected as the band-pass transmission spectrum of the filter is tuned from one wavelength to another. That is, transmission only occurs at the wavelengths desired. This is needed for so-called “reconfigurable network” OADM elements, whereby intermediate reflected or “express” channels should not be dropped as the tunable OADM is changed from one optical channel to another.

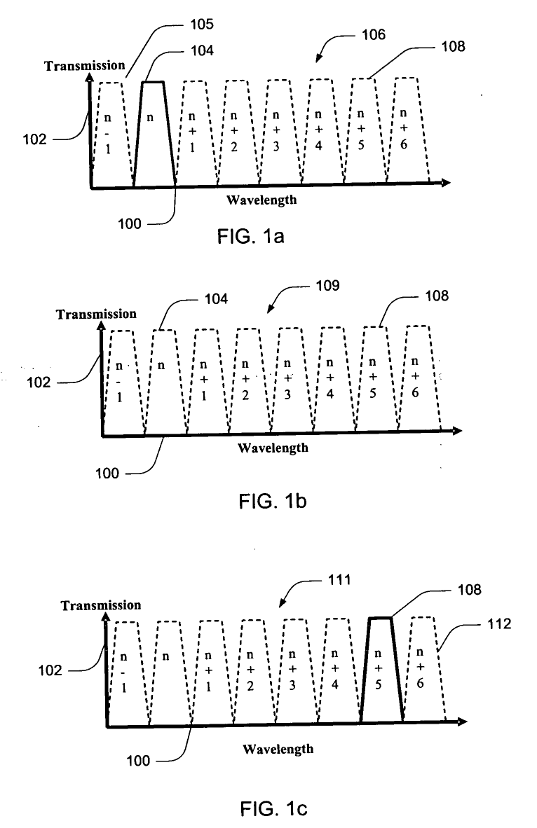

FIG. 1a to FIG. 1c are graphical representations of the operation of a non-blocking tunable filter in accordance with an exemplary embodiment of the present invention. In the graphs, the possible outputs of a non-blocking tunable optical filter are illustrated along a graph of transmission versus wavelength for specific channels having defined wavelength bands. The channels processed by the filter are illustrated on a graph having each channel plotted along an X axis 100 and relative transmission of the wavelengths in the channel along a Y axis 102. A transmitted (dropped) channel is illustrated as a channel with a solid outline. A reflected (expressed) channel is illustrated by a dashed outline.

Referring now to FIG. 1a, channel n 104 is shown as being a currently dropped channel with a solid outline. Channel n−1 105 and channels n+1 to N+6 106 are shown as being expressed with a dashed outline. During a tuning process, the non-blocking tunable filter is tuned from the current channel 104 to a target channel, n+5 108, without blocking the intermediate channels.

FIG. 1b is a graph of the state of a non-blocking tunable filter during a transitional or tuning phase. As illustrated, channels n−1 to n+6 109 are shown as being expressed using a dashed outline. During the transitional phase, all channels are expressed as the non-blocking tunable filter tunes from a current channel 104 to the target channel 108.

FIG. 1c is a graph of the state of a non-blocking tunable filter after it has tuned to a target dropped channel. In the graph, channels n−1 to n+4 111 and channel n+6 112 are shown with dashed outlines indicating that they are expressed by the non-blocking tunable filter. Channel n+5 108 is shown with a solid outline indicating that it is being dropped or transmitted by the non-blocking tunable filter.

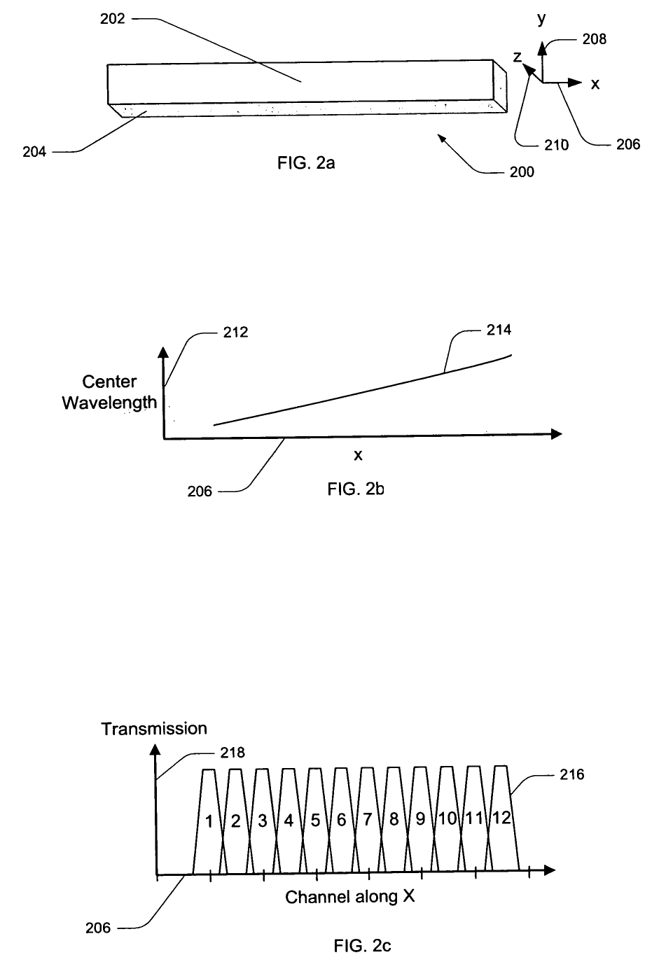

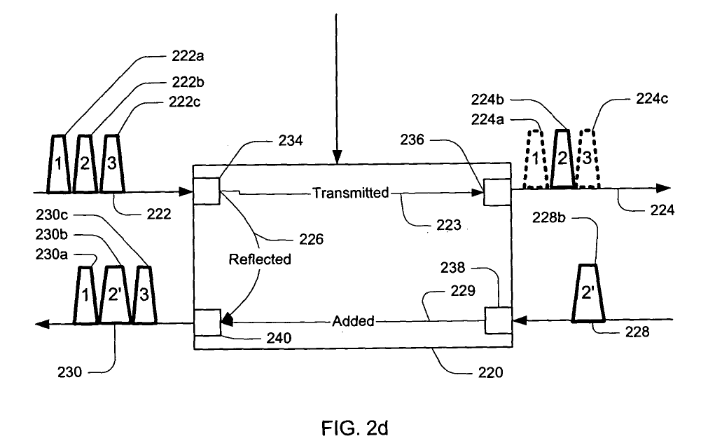

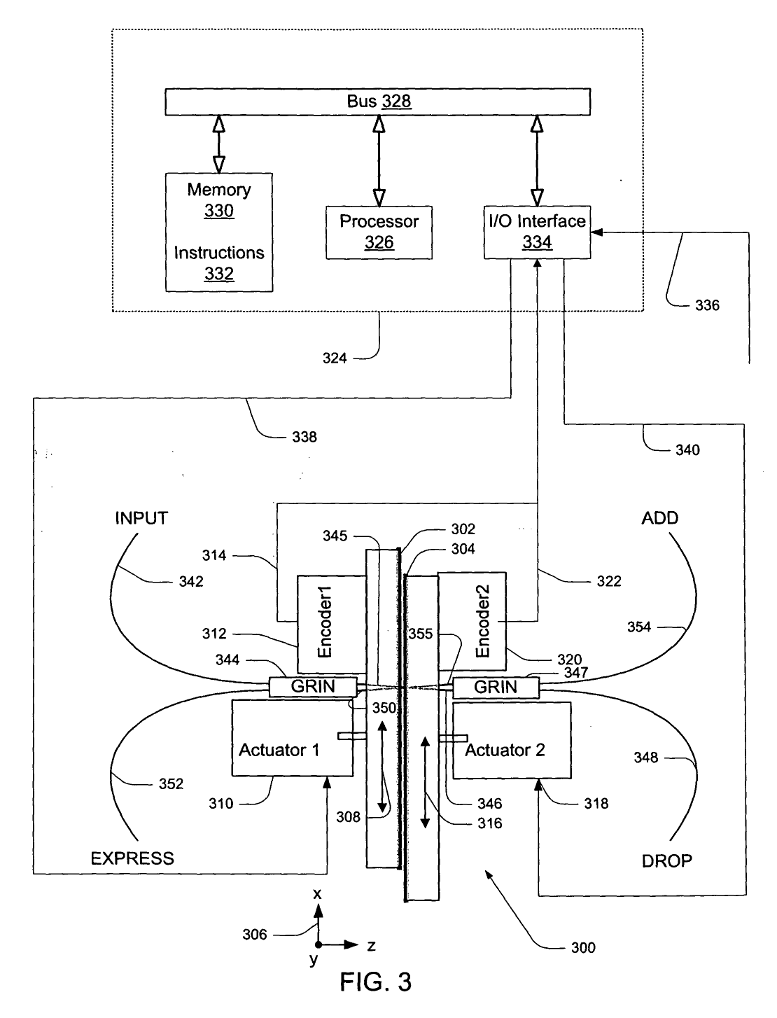

FIG. 2a is a diagram of a linearly variable filter in accordance with an exemplary embodiment of the present invention. A thin film linearly variable filter (LVF) 200 is an optical filter that has a spatially variable wavelength along one direction of the filter surface in an approximately linear profile. It is achieved in the thin film coating process by any of a number of techniques. A thin film of optically active coating 202 is overlaid on a larger optical substrate 204 that supplies mechanical rigidity to the LVF. The optical characteristics of the LVF vary along one axis, as depicted herein the X axis 206. However, the optical characteristics of the LVF do not vary substantially along a Y axis 208 or a Z axis 210. The nature of the variation in optical characteristics along the X axis are illustrated in FIG. 2a and FIG. 2b as described below.

Referring now to FIG. 2b, FIG. 2b is a graphical representation of the center frequency of a transmitted optical signal as a function of the X axis of the linearly variable filter of FIG. 2a in accordance with an exemplary embodiment of the present invention. In the graph, the center wavelength of an optical signal that is transmitted through the LVF 200 (of FIG. 2) is shown on axis 212. Moving along the X axis 206 of the LVF, the center wavelength of a transmitted optical signal increases monotonically as indicated by line 214. This means that the wavelength of light preferentially transmitted by the LVF changes along the X axis of the LVF. However, moving along the Y axis 208 or Z axis 210 (both of FIG. 2a) does not result in a change in the wavelength of light transmitted by the LVF.

Referring now to FIG. 2c, FIG. 2c is a graphical representation of the spectral transmission characteristics as a function of distance along the X axis of the linearly variable filter of FIG. 2a in accordance with an exemplary embodiment of the present invention. Moving along the X axis 206 of the LVF 200 (of FIG. 2a), the LVF exhibits regions of high optical transmittance 216, that correlate with channels in an optical signal. For example, an optical channel with a central wavelength and specified bandwidth, there will be a position along the X axis of the LVF at which the channel is preferentially transmitted or dropped by the LVF. Everywhere else along the X axis, the channel will be substantially reflected or expressed by the LVF.

This feature of a thin film LVF allows an LVF to be used within a tunable Optical Add-Drop Module (OADM). This is because the LVF requires only X axis translation of the thin film interference filter within a standard thin film filter OADM configuration. Adverse polarization and angle induced effects common in angle tuned thin film filters are reduced in this approach. A reflected light portion is also readily collected in a conventional manner, as the filter incidence angle does not change as the LVF is tuned by translation along the X axis. Inserting a second LVF in series with a first LVF allows non-blocking (“hitless”) tuning operation and “flexible” bandwidth control, making tunable LVF based OADM devices fully reconfigurable. This is achieved by adjusting the spectral transmission overlap of the two LVFs.

FIG. 2d is a block diagram of the operation of a wavelength tunable filter in accordance with an exemplary embodiment of the present invention. A wavelength tunable filter 220 receives an input optical signal 222 at an input port 234. The input optical signal may have multiple channels with each channel occupying a specific bandwidth of wavelengths, such as channel 1 222a, channel 2 222b, channel 3 222c, and channel 4 222d. In the input optical signal, some of the channels may be present and are indicated using a solid outline, such as channels 1 through 3. Some of the channels may be absent, such as channel 4, as indicated by a dashed outline.

Within the tunable filter, a dropped channel is transmitted (223) through the device and out of a drop port 236 as a component of a dropped optical signal 224. As illustrated, the dropped optical signal includes dropped channel 2 224b as indicated by channel 2's solid outline. Channels 1 224a, 3 224c, and 4 224d are not present in the dropped optical signal as indicted by their dashed outlines.

The input channels that are not transmitted as part of the dropped optical signal and are reflected (226) by the device as components of an expressed optical signal 230 out of an express port 240. Channels may also be added (229) to the expressed optical signal by the filter. For example, an add optical signal 228 at an add port 238 may contain a channel such as channel 4 228d as indicated by channel 4's solid outline. Absent channels, such as channel 1 228a, channel 2 228b, and channel 3 228c are indicated with dashed outlines. The resultant expressed optical signal 230 then includes channel 1 230a, channel 3 230c, and channel 4 230d. Channel 2 230b is absent as it was dropped as is shown by channel 2's dashed outline.

FIG. 3 is a block diagram of a non-blocking tunable filter employing two linearly variable filters in accordance with an exemplary embodiment of the present invention. A non-blocking tunable filter 300 employs a first LVF 302 optically coupled to a second LVF 304. The first LVF is translated along its X axis 306, as indicated by arrow 308, by a first actuator 310 mechanically coupled to the first LVF. The amount of translation along the X axis of the first LVF may be measured by a first encoder 312 mechanically or optically coupled to the first LVF. As the first actuator moves the first LVF, the first encoder generates a first LVF translation signal 314 indicative of the amount of translation of the first LVF or the absolute position of the first LVF.

The second LVF is translated along its X axis, as indicated by arrow 316, by a second actuator 318 mechanically coupled to the second LVF. The amount of translation along the X axis of the second LVF may be measured by a second encoder 320 mechanically or optically coupled to the second LVF. As the second actuator moves the second LVF, the second encoder generates a second LVF translation signal 322 indicative of the amount of translation of the second LVF or the absolute position of the second LVF.

The operations of the non-blocking tunable filter are controlled by a controller 324 electronically coupled to the first and second actuators and the first and second encoders. The controller includes a processor 326 coupled via a bus 328 to a memory 330. The memory includes programming instructions 332 executable by the processor to control the operations of the non-blocking tunable filter. The controller further includes an Input/Output (I/O) interface 334 for receiving external input signals 336 and receiving LFV translation signals. In addition, the I/O interface is used by the controller to transmit first actuator command signals 338 and second actuator control signals 340 to the first and second actuators respectively.

Optical signals including channels to be dropped and channels to be expressed may be introduced into the non-blocking tunable filter via an optical fiber 342 serving as an input port. The input port includes a first GRadient INdex (GRIN) collimator (or other light collimating device) for injection of the input optical signal 345 into the first LVF. A portion 350 of the input optical signal including channels reflected by the LVF are reflected back into the first GRIN collimator and out through an optical fiber 352 as an expressed optical signal. Another portion 346 of the input optical signal corresponding to one or more dropped channels is transmitted through the first LVF and the second LVF and collected by a second GRIN collimator 347 coupled to a drop port optical fiber 348.

Add optical signals may be introduced into the non-blocking tunable filter through an add optical port 354 that may be composed of an optical fiber coupled to the second GRIN collimator. An add optical signal 355 including one or more add channels is introduced into the second LVF by the second GRIN lens, transmitted through the second and first LVFs, and then collected by the first GRIN collimator and added to the expressed channels in the expressed optical signal transmitted out of the express port.

The radius of the filter surfaces should be minimal, as an excessive radius may cause optical signal beam misalignments and corresponding wavelength dependant loss as the LVFs are linearly translated along their respective X axes. This is especially the case with the reflected or expressed optical signal, which undergoes a double angle deflection relative to any radius induced incidence angle. In addition, making the filter substrates very thick along the Z axis reduces bowing radius from stresses applied to the LVFs. Alternatively, smaller beam collimators with larger acceptance angles may be used to reduce the tuning dependant loss from such curvatures.

The operation of the wavelength tunable filter may be summarized by considering two states of the first and second LVFs. In one state, the first and second LVFs are positioned so that they drop the same channels from an input optical signal. In another state, the first and second LVFs are positioned so that they drop different channels.

If the first and second LVFs are positioned to drop the same channels, an input optical signal is processed in the following manner. The first LVF receives the input optical signal having one or more channels to be dropped. The first LVF transmits the selected drop channels to the second LVF as components of an intermediate dropped optical signal. The second LVF receives the intermediate dropped optical signal including the selected drop channels and transmits the selected drop channels through to the drop port as components of a dropped optical signal. Any channels in the input optical signal reflected by the first or second LVF and any channels added by the second LVF within the drop band of the first LVF are collected by the first GRIN collimator and transmitted out of the express port.

If the first and second LVFs are positioned to drop different channels, an input optical signal is processed in the following manner. The first LVF receives the input optical signal and transmits an intermediate dropped optical signal including any dropped channels to the second LVF. However, as the second LVF is positioned to drop different channels, the second LVF reflects the channels dropped by the first LVF back to the first LVF as an intermediate expressed optical signal including the channels originally dropped by the first LVF. No channels reach the second GRIN collimator or the drop port.

Any added channels received by the second filter are also transmitted to the first LVF as part of the intermediate expressed optical signal. The first LVF receives the intermediate expressed optical signal, including the intermediate dropped channels transmitted by the first LVF to the second LVF, as an add optical signal. The first LVF's expressed optical signal then includes all of the channels reflected by the first LVF, any channels originally dropped by the first LVF but expressed by the second LVF, and any of the channels added by the second LVF that overlap the drop channels of the first LVF.

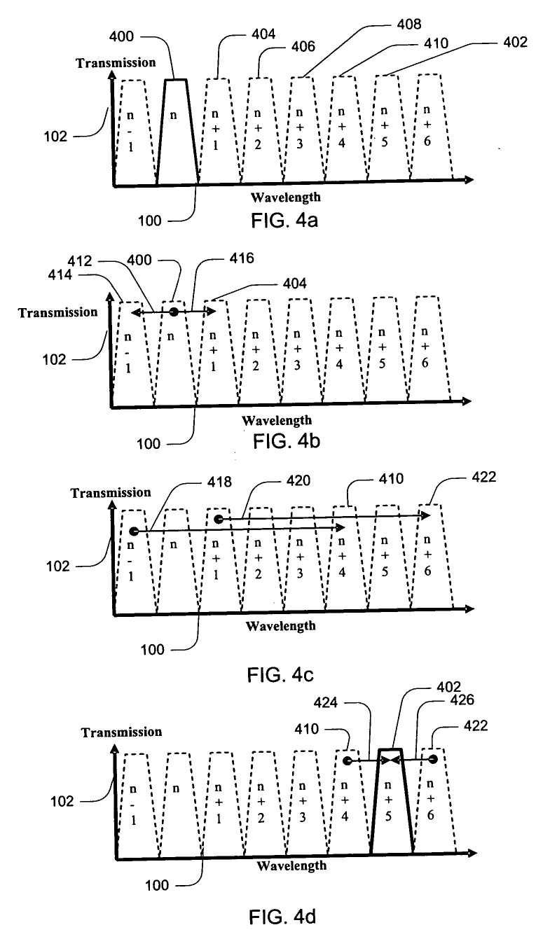

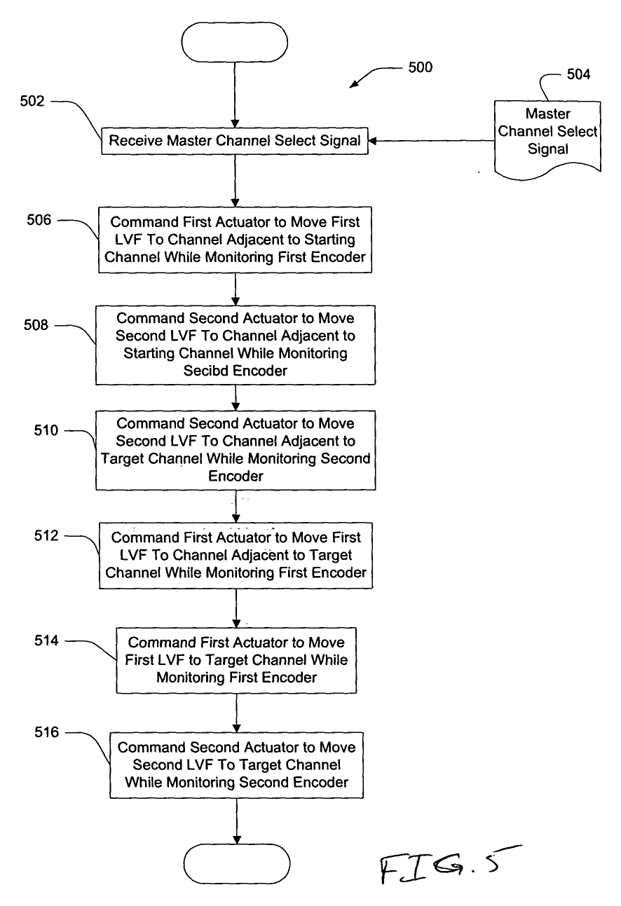

FIG. 4a to FIG. 4b are a sequence of graphs illustrating the operation of a non-blocking tunable filter in accordance with an exemplary embodiment of the present invention.

In the graphs, the possible outputs of a non-blocking tunable optical filter are illustrated along a graph of transmission versus wavelength for specific channels having defined wavelength bands. The channels processed by the filter are illustrated on a graph having each channel plotted along an X axis 100 and relative transmission of the wavelengths in the channel along a Y axis 102. A transmitted or dropped channel is illustrated as a channel with a solid outline. A reflected or expressed channel is illustrated by a dashed outline.

Referring now to FIG. 4a, initially, the first LVF 302 and the second LVF 304 (both of FIG. 3) are tuned to a starting channel, channel n 400, thus allowing transmission of the starting channel. To tune to a target channel, in this example channel n+5 402, each filter needs to pass through expressed channels n+1 404, n+2 406, n+3 408, and n+4 410.

Referring now to FIG. 4b, the first LVF 302 (of FIG. 3) is detuned (412) from the starting channel n 400 to a channel adjacent to the starting channel, channel n−1 414. The second LVF 304 (of FIG. 3) is simultaneously detuned (416) to another channel adjacent to the starting channel but in an opposite direction as the first LVF from the current channel, in this case channel n+1 404. As noted above, as the first and second LVFs are tuned to different channels, all of the channels are reflected as express channels as indicated by the dashed outlines of the illustrated channels.

Referring now to FIG. 4c, the second LVF 304 (of FIG. 3) is tuned to a channel adjacent to the target channel, in this example to channel n+6 422. The first LVF 302 (of FIG. 3) is tuned (418) to another channel adjacent to the target channel but in an opposite direction as the second filter, in this example to channel n+4 410. At no time are the two LVF's set to the same wavelength (channel) during this tuning step.

Referring now to FIG. 4d, the first LVF is tuned (424) to the target channel 402 from the first LVF's adjacent channel 410. The second LVF is tuned simultaneously (426) from the second LVF's adjacent channel 422 to the target channel 402. As both LVFs are now tuned to the target channel, the target channel is dropped by both LVFs as indicated by the target channels solid outline.

FIG. 5 is a process flow diagram of a tuning process for a non-blocking tunable filter in accordance with an exemplary embodiment of the present invention. A controller 301 (of FIG. 3) uses a tuning process 500 to tune a non-blocking tunable filter 300 (of FIG. 3). The controller receives (502) a master channel select signal 504 indicating which channels should be dropped. In response to the master channel select signal, the controller commands (506) a first actuator 310 (of FIG. 3) to position the first LVF 302 (of FIG. 3) to drop a channel adjacent to the starting channel. The controller determines the position of the first LVF by monitoring first LVF translation signals 314 (of FIG. 3) generated by a first encoder 312 (of FIG. 3). The controller simultaneously commands (508) a second actuator 318 (of FIG. 3) to position the second LVF 304 (of FIG. 3) to drop a second channel adjacent to the starting channel wherein the second adjacent channel and the first adjacent channel are not the same. The controller determines the position of the second LVF by monitoring second LVF translation signals 322 (of FIG. 3) generated by a second encoder 312 (of FIG. 3) in response to movement of the second LVF.

Once both LVFs are in position adjacent to the starting channel, the controller commands (510) the second actuator to position the second LVF to drop a third channel adjacent to a selected target channel. The controller determines the position of the second LVF by monitoring second LVF translation signals generated by the second encoder. The controller also commands (512) the first actuator to position the first LVF to drop a fourth channel adjacent to the target channel wherein the fourth adjacent channel and the third adjacent channel are not the same. The controller determines the position of the first LVF by monitoring first LVF translation signals generated by the first encoder in response to movement of the first LVF. The two LVF channels never overlap during this tuning step.

Once both LVFs are in position to drop channels adjacent to the target channel, the controller commands (514) the first and second actuators to simultaneously position the first and second LVFS to drop the selected target channel. The controller determines the position of the first LVF by monitoring first LVF translation signals generated by the first encoder. The controller determines the position of the second LVF by monitoring second LVF translation signals generated by the second encoder in response to movement of the second LVF. After the end of the process, the tunable wavelength filter has positioned the LVFs to drop the target channels and express any other channels from the input optical signal.

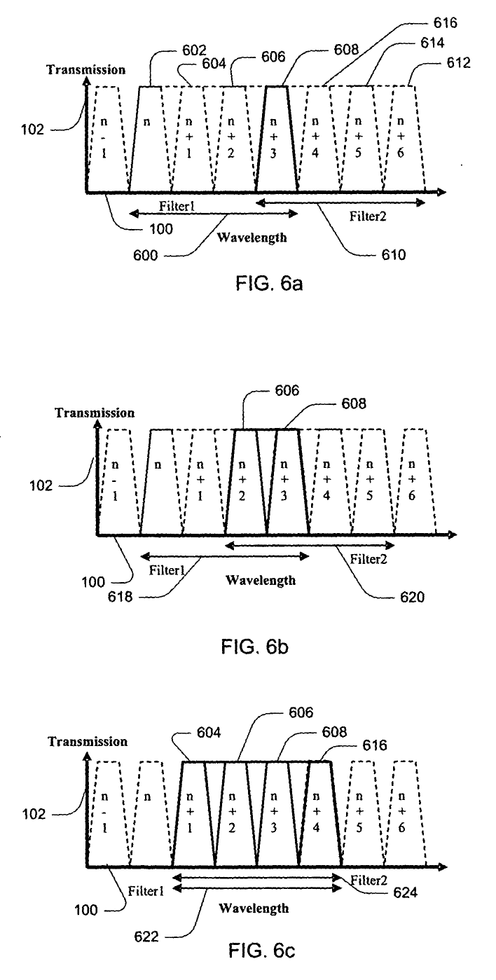

FIG. 6a to FIG. 6c are graphical representations of the operation of a flexible bandwidth non-blocking tunable filter in accordance with an exemplary embodiment of the present invention. LVFs may be created to drop blocks of adjacent channels from a WDM optical signal. Two such LVFS, optically coupled in series as previously described, may be advantageously employed to provide flexible control to drop one or more channels simultaneously. In the graphs, the possible outputs of a non-blocking tuned optical filter are illustrated along a graph of transmission versus wavelength for specific channels having defined wavelength bands. The channels processed by the filter are illustrated on a graph having each channel plotted along an X axis 100 and relative transmission of the wavelengths in the channel along a Y axis 102. A transmitted or dropped channel is illustrated as a channel with a solid outline. A reflected or expressed channel is illustrated by a dashed outline.

Referring now to FIG. 6a, a first LVF 302 (of FIG. 3) is positioned to drop a first set 600 of channels, namely channel n 602, channel n+1 604, channel n+2 606, and channel n+3 608. A second LVF 304 (of FIG. 3) is positioned to drop a second set 610 of channels, namely channel n+6 612, channel n+5 614, channel n+4 616, and channel n+3 608. As the first and second LVFs have one common dropped channel, channel n+3, the common dropped channel is included in a dropped optical signal generated by the tunable wavelength filter as indicated by channel n+3's solid outline. All of the rest of the channels, including those channels dropped by either the first LVF or the second LVF but not by both LVFs, are expressed as indicated by the channels dashed outlines.

Referring now to FIG. 6b, the first LVF 302 (of FIG. 3) is tuned to drop a first set of channels 618. The second LVF 304 (of FIG. 3) is tuned to drop a second set of channels 620. In this configuration, the overlap or intersection between the first and second set of dropped channels includes channel n+2 606 and channel n+3 608. As such, both channels are dropped by both LVFs and included in a dropped channel optical signal transmitted from the tunable wavelength filter as indicated by the included channel's solid outlines. All the rest of the channels are expressed as indicated by their dashed outlines. In the case where there is no overlap between the first and second set of dropped channels, that is the intersection between the two sets is empty, all of the channels will be expressed.

Referring now to FIG. 6c, a first set of dropped channels 622 dropped by the first LVF 302 (of FIG. 3) is identical to a second set of channels 624 dropped by the second LVF 304 (of FIG. 3). As such, channel n+1 604, channel n+2 606, channel n+3 608, and channel n+4 616 are included in a dropped channel optical signal transmitted from the tunable wavelength filter as indicated by the included channel's solid outlines. All the rest of the channels are expressed as indicated by their dashed outlines.

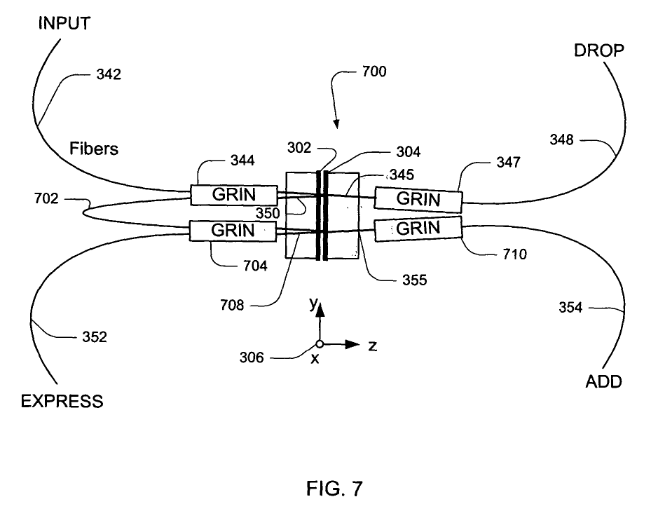

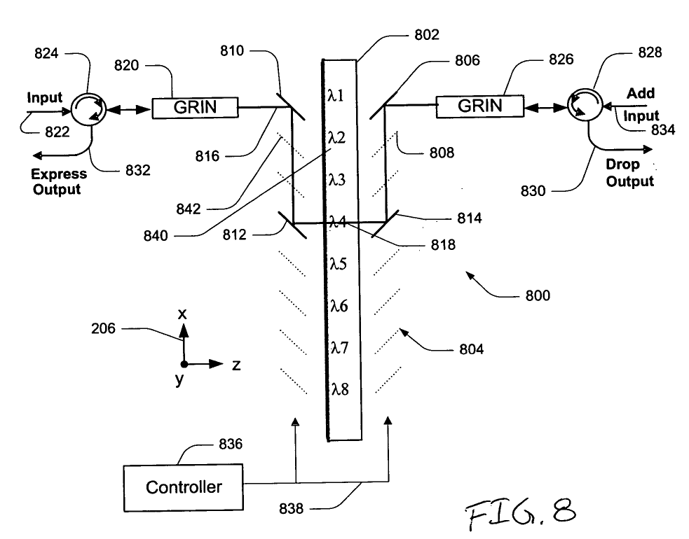

FIG. 7 is a block diagram of a cascaded tunable wavelength filter in accordance with an exemplary embodiment of the present invention. Higher reflection isolation (express port isolation) may be achieved than is possible from a single reflection from a LVF by cascading tunable wavelength filters. Reflection isolation indicates how much of the drop (transmitted) channel wavelength signal at the input port makes it to the reflected (express) port. Ideally this portion is zero (high isolation). Even more difficult to achieve is high reflection isolation in a LVF over the entire X tuning range of the LVF. One approach in the industry for fixed wavelength modules is to cascade the input/express ports of two or more OADMs. This same approach can be used for tunable OADMs created from LVFs to achieve the requisite isolation. With an LVF, the wavelength slope is high in the tuning direction (X in this case), and typically very small in the orthogonal surface direction (Y). Thus, for this embodiment, a tunable OADM may be cascaded with itself as shown in FIG. 7. FIG. 7 is similar to FIG. 3, however the block diagram of FIG. 7 is a semi-schematic view along the X axis 306 resulting in a top view of a device similar to the device depicted in FIG. 3. In this block diagram, the actuators and encoders of FIG. 3 have been removed for clarity. In this embodiment, the first LVF 302 is used in a cascaded series mode by re-injecting the expressed optical signal generated by the first LVF back into the first LVF for further processing.

The cascaded tunable wavelength filter includes an input port 342 having a first GRIN collimator 344 for injection of an input optical signal into the first LVF as previously described. However, in contrast to the embodiment illustrated in FIG. 3, a first expressed optical signal 702 generated by the first LVF is reinjected into the first LVF at substantially the same X location but at a different Y location by a third GRIN collimator 704. As the first expressed optical signal includes primarily expressed channels, reinjecting the expressed optical signal back into the LVF generates a second expressed optical signal 708 including the previously expressed channels. Any residual optical signal remaining from any dropped channels is therefore further reduced in strength in the second expressed optical signal as the residual optical signal is dropped by the first LVF. The second expressed optical signal is then collected by the third GRIN collimator and transmitted out of the cascaded tunable wavelength filter as an expressed optical signal out of the express port 352.

The intermediate dropped channel signal 345 transmitted by the first LVF into the second LVF is collected by the second GRIN collimator 347 as previously described and transmitted out of the cascaded tunable wavelength filter as a dropped optical signal. The cascaded tunable optical filter may also accept an add optical signal from an add port 354 coupled to a fourth GRIN collimator 710. The fourth GRIN collimator injects the add optical signal, including any add channels, into the second LVF. The second LVF receives the add channels and transmits them as an intermediate add optical signal to the first LVF. The third GRIN collimator collects the add optical signal as it emerges from the first LVF. The third GRIN collimator combines the add optical signal with the second express optical signal before the expressed optical signal is transmitted out of the cascaded tunable wavelength filter as an expressed optical signal out of the express port.

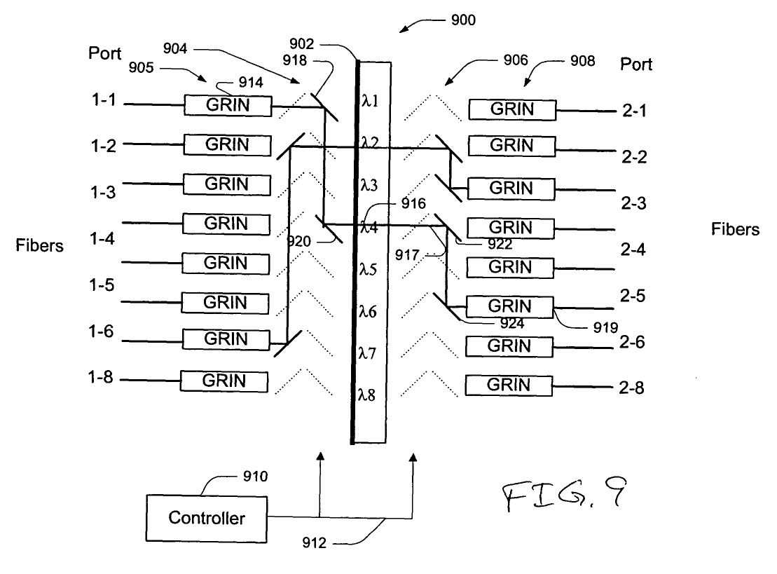

FIG. 8 is a block diagram of a Micro-ElectroMechanical Systems (MEMS) tunable wavelength filter in accordance with an exemplary embodiment of the present invention. In cases where the linearity of the LVF's variation in wavelength is very linear, it is possible to implement a MEMS version of a tunable wavelength filter. In this embodiment, millisecond selector speeds may be realized. Not only high linearity of the LVF is required, but a specific gradient to the center wavelength (CWL) slope is used to assure that the switched optical channels fall on the International Telecommunication Union (ITU) grid. Advantages to the MEMS approach are that, besides the micro mirrors, there are no moving parts, and the MEMS actuator technology can potentially be manufactured at less cost than mini-motors and encoders. However, unlike the sliding approach the MEMS approach offers only discrete channel wavelength selection.

In a MEMS tunable wavelength filter 800, a LVF 802 is positioned so that a plurality of MEMS “pop-up” double sided mirrors 804 may control the path of an optical signal through the LVF. When a mirror is in its down position, as indicated by mirror 808 shown with a dashed line, the mirror does not interfere with an optical signal being injected into and received from the LVF. In its up position, such as mirror 806 shown with a solid line, the mirror redirects the path of the optical signal. In the illustrated example, mirror 810, mirror 812, mirror 814, and mirror 806 define the path of an optical signal 816 such that it passes through a portion of the LVF corresponding to a fourth channel 818 as indicated by the symbol “λ4”. The LVF may preferentially transmit different channels along its X axis 206 as previously described.

A first GRIN collimator 820 receives an input optical signal 822 from a first optical circulator 824. The input optical signal includes a plurality of channels including selected drop channels. The input optical signal is injected into the LVF by the first GRIN collimator along the optical path described by mirrors 810, 812, 814, and 806 to a second GRIN collimator. Any channels dropped by the LVF are received by the second GRIN collimator and transmitted to a second optical circulator 828 as a dropped optical signal including a dropped channel. The dropped optical signal is transmitted out of the MEMS tunable wavelength filter as a dropped optical signal 830.

Any channels in the optical input signal and reflected by the LVF are routed along the optical path by mirrors 812 and 810 as an expressed optical signal to be collected by the first GRIN collimator. The first GRIN collimator transmits the collected expressed optical signal to the first optical circulator to be transmitted out of the MEMS tunable wavelength filter as an expressed optical signal 832.

To add a channel, the MEMS tunable wavelength filter receives an add optical signal 834 including an add channel at the second optical circulator. The second optical circulator transmits the add optical signal to the second GRIN collimator which injects the add optical signal into the LVF along the optical path defined by mirrors 806, 814, 812, and 810. The first GRIN collimator collects the add optical signal and transmits the add optical signal to the first optical circulator. The first optical circulator receives the add optical signal and adds any add channels to the expressed optical signal.

To tune the MEMS tunable wavelength filter, a controller 836, similar to the controller 301 of FIG. 3, transmits mirror control signals 838 to the plurality of mirrors to define optical paths through different portions of the LVF. For example, to define a path through the portion of the LVF corresponding to channel λ2 840, the controller would command mirrors 842 and 808 to come up and mirrors 812 and 814 to lay back down.

FIG. 9 is a block diagram of a MEMS multiport optical switch employing a LVF and mirrors in accordance with an exemplary embodiment of the present invention. An extension of the MEMs concept of FIG. 8 allows optical multi-port switching capability. By adding more fiber ports and mirrors, any input can be switched through any wavelength to any output. Multiple signal paths can be accommodated as long as the multiple signal paths do not block each other and do not occupy the same channel. As in the embodiment of FIG. 8, optical circulators can be used to realize add/drop functions between any two ports.

In a MEMS multiport optical switch 900, a plurality of MEMS mirrors 904 on one side of a LVF 902 and a plurality of MEMS mirrors on a second side of the LVF 906 are used to define a plurality of filtered optical paths through the LVF. The plurality of optical paths may be used to arbitrarily optically couple a first plurality of GRIN collimators 905 corresponding to a first set of ports to a second plurality of GRIN collimators 908 corresponding to a second set of ports. A controller 910, similar to controller 301 of FIG. 3, transmits mirror command signals 912 to the plurality of mirrors on each side of the LVF to create various optical paths. For example, an optical path starting at GRIN collimator 914 in the first set of ports may be defined to route an optical signal 917 through a portion of the LVF 916 corresponding to channel λ4 and then to GRIN collimator 919. To do so, the controller commands mirrors 918, 920, 922, and 924 to raise themselves up to create the desired optical path. In a similar manner, multiple optical paths may be defined from the first set of ports to the second set of ports.

Although this invention has been described in certain specific embodiments, many additional modifications and variations would be apparent to those skilled in the art. It is therefore to be understood that this invention may be practiced otherwise than as specifically described. Thus, the present embodiments of the invention should be considered in all respects as illustrative and not restrictive, the scope of the invention to be determined by any claims supported by this application and the claims' equivalents rather than the foregoing description.

What is claimed is:

1. A tunable wavelength filter; comprising:
an optical path having an input port and a drop port;
a linearly variable filter within the optical path; and
an actuator mechanically coupled to the linearly variable filter, the actuator operable to position a portion of the linearly variable filter corresponding to an optical channel in the optical path.

2. The tunable wavelength filter of claim 1, further comprising:
a second linearly variable filter within the optical path, the second linearly variable filter optically coupled to the first linearly variable filter; and
a second actuator, mechanically coupled to the second linearly variable filter, the second actuator operable to position a portion of the second linearly variable filter corresponding to an optical channel in the optical path.

3. The tunable wavelength filter of claim 1, wherein:
the portion of the first linearly variable filter positioned in the optical path corresponds to a plurality of optical channels; and
the portion of the second linearly variable filter positioned in the optical path corresponds to a plurality of optical channels.

4. The tunable wavelength filter of claim 1, further comprising:
a first collimator receiving a reflected optical signal generated by the linearly variable filter in response to an input optical signal; and
a second collimator optically coupled to the first collimator, the second collimator receiving the reflected optical signal from the first collimator and transmitting the reflected optical back to the linearly variable filter.

5. A tunable wavelength filter; comprising:
a linearly variable filter; and
a plurality of movable mirrors defining an optical path through a portion of the linearly variable filter corresponding to an optical channel.

6. The tunable wavelength filter of claim 5, further comprising a first plurality of collimators corresponding to a first set of ports and a second plurality of collimators corresponding to a second set of ports, wherein the movable mirrors are operable to define a path through the linearly variable filter between a first collimator selected from the first plurality of collimators and a second collimator selected from the second plurality of collimators.
